(19) United States
(12) Patent Application Publication
(10) Pub. No.: US 2002/0061675 A1
(43) Pub. Date: May 23, 2002

(54) Clamping connector

(76) Inventor: Joachim Borst, Donaueschingen (DE)

Correspondence Address: Hutchins, Wheeler & Dittmar, 101 Federal Street, Boston, MA, 02110, US

(21) Appl. No.: 09/888,327

(22) Filed: Jun. 22, 2001

(30) Foreign Application Priority Data
Nov. 20, 2000 (DE) 100 57 428.9

(51) Int. Cl. H01R 4/24; H01R 4/26; H01R 11/20

(52) U.S. Cl. 439/404

(57) ABSTRACT

A clamping connector is described in which a pressure element moves up and down in a housing. A conductor to be connected is inserted into a hole in the pressure element and can be pressed into an insulation displacement contact by moving the pressure element downwards. An operating lever which is swivelably mounted in the housing is used to move the pressure element.

### BACKGROUND

1. Field of the Invention

The present invention relates to electrical connectors, and in particular to a clamping connector.

2. Description of Related Art

Clamping connectors may be placed, in particular, on PCBs and soldered to them so that conductors, in particular the cores of a cable, can be connected to the circuitry on the PCB. The clamping connector may be embodied as a single-pole or multi-pole clamp. A contact element, which is connected to the PCB via a connection, preferably a soldered connection, and has an insulation displacement contact, is assigned to each pole of the clamping connector. A pressure element which has a hole into which the conductor to be connected can be inserted, is movably guided in the clamping connector's housing. When the pressure element is in an upper position, the hole is located above the insulation displacement contact so that the conductor to be connected can be inserted into the hole. If the pressure element is then moved downwards, the insulation displacement contact penetrates the pressure element and crosses the hole so that when the insulation material is pierced contact is established with the conductor that is placed in the hole.

### SUMMARY OF THE INVENTION:

An object of the present invention is to embody a clamping connector so that a conductor can be connected without the need for a tool.

According to the present invention, this object is achieved via a clamping connector, comprising: at least one housing made of an insulating material, a contact element inserted in the base of the housing which has a connector which protrudes from the base and an insulation displacement contact which extends into the housing; a pressure element made of an insulating material which is movably guided up and down in the housing and has a hole which is parallel to the base of the housing and perpendicular to the front of the housing into which a conductor to be connected can be inserted via an insertion opening in the front wall, the hole being located above the insulation displacement contact when the pressure element is in an upper position, and the insulation displacement contact penetrating the pressure element and establishing a contact with the conductor that has been inserted into the hole when the pressure element is in a lower position; and wherein an operating lever for moving the pressure element is swivelably mounted in the housing and acts on the pressure element above the hole.

In accordance with one aspect of the invention, an operating lever which acts on the pressure element so as to move it in the housing, is attached to the housing. The operating lever may be swiveled manually, so that no tool is required to connect the conductor. The conductor is placed in the hole of the pressure element manually, whereupon the latter is pressed down by hand via operation of the operating lever, so that the insulation displacement contact penetrates the pressure element and makes contact with the conductor.

Preferably the top opposite the base of the housing is open so that the pressure element can be accessed from the top of the housing. Thus the operating lever can be arranged on the top of the housing and extends across the housing and the pressure element arranged in the housing. As a result, the operating lever is easily accessible and can be operated simply and easily. Herein, it is useful that the operating lever is attached to the rear of the housing and extends forwards across the surface of the housing so that the free end of the lever, which can be operated manually, is accessible at the front of the housing, from where the conductor to be connected is inserted into the clamping connector.

According to another aspect of the invention, the pressure element can be operated manually via the operating lever and can also be operated via a tool, in particular, a screwdriver. To accomplish this, the pressure element has on its front an intervention recess into which it is possible to intervene by inserting a tool through an opening in the front of the housing. If the tool is swiveled up and down and supported on the edges of the opening, it shifts the pressure element in the housing via exertion of leverage. In accordance with this embodiment, it is possible to move the pressure element using a screwdriver, or manually via the operating lever. Because operation of the pressure element can be carried out in a variety of ways, it is much easier to connect the conductor in different installation situations and under different conditions of accessibility of the clamping connectors. Preferably the operating lever is a separate component that can be snapped into a swivel bearing in the housing. This makes it easier to manufacture the clamping connector and to mount the operating lever in the housing. In addition, the clamping connector having the same design may optionally be delivered without the operating lever if the latter is not required, e.g. due to the clamping connector's installation situation.

In accordance with yet another aspect of the invention is a clamping connector comprising: a housing having a first hole formed therein and a contact element; and a pressure element arranged in the housing such that said pressure element can move up and down in said housing, said pressure element having a second hole, said first and second holes capable of receiving a conductor to be connected, said pressure element having a first upward position and a second lower position such that when said pressure element is arranged in said second lower position, a conductor inserted into said first and second holes is connected to a portion of said contact element.

In accordance with still another aspect of the invention is a method of connecting a conductor to a clamping connector comprising: positioning a pressure element arranged in a housing in an upper position, wherein, in said upper position, a hole in said pressure element is aligned with another hole in said housing; inserting said conductor through said hole in said pressure element and said other hole in said housing; and positioning said pressure element into a lower position, wherein, in said lower position, an insulation displacement contact, extending into said housing, passes through the hole of said pressure element making contact with a core included in said conductor.

### BRIEF DESCRIPTION OF THE DRAWINGS

Features and advantages of the present invention will become more apparent from the following detailed description of exemplary embodiments thereof taken in conjunction with the accompanying drawings in which:

FIG. 1 shows the clamping connector, embodied as a 4-pole clamping connector, in perspective view;

FIG. 2 shows the individual components of the clamping connector, in a perspective view;

FIG. 3 shows a vertical section through the housing of the clamping connector, along section line III in FIG. 4;

FIG. 4 shows a front view of the housing;

FIG. 5 shows a section view of the clamping connector that corresponds to FIG. 3, with the operating lever in the pressure element's upper position, per section line V-V in FIG. 6;

FIG. 6 shows a front view of the clamping connector in the position shown in FIG. 5;

FIG. 7 shows a view of the clamping connector that corresponds to FIG. 5, with the pressure element in the lower position;

FIG. 8 shows a view of the clamping connector that corresponds to FIG. 5, without the operating lever, with the pressure element in the upper position per section line VIII-VIII in FIG. 9;

FIG. 9 shows a front view of the clamping connector in the position shown in FIG. 8; and

FIG. 10 shows a section view of the clamping connector that corresponds to FIG. 8, with the pressure element in the lower position.

### DESCRIPTION OF PREFERRED EMBODIMENT(S)

In the single-pole embodiment, the clamping connector includes housing 10, pressure element 20, which is arranged in housing 10, operating lever 30, and contact element 40. Housing 10, pressure element 20, and operating lever 30 are made of an insulating material, and in particular are manufactured as plastic injection-molded components. Contact element 40 is a stamped metal component made of a resilient electrically conducting metal.

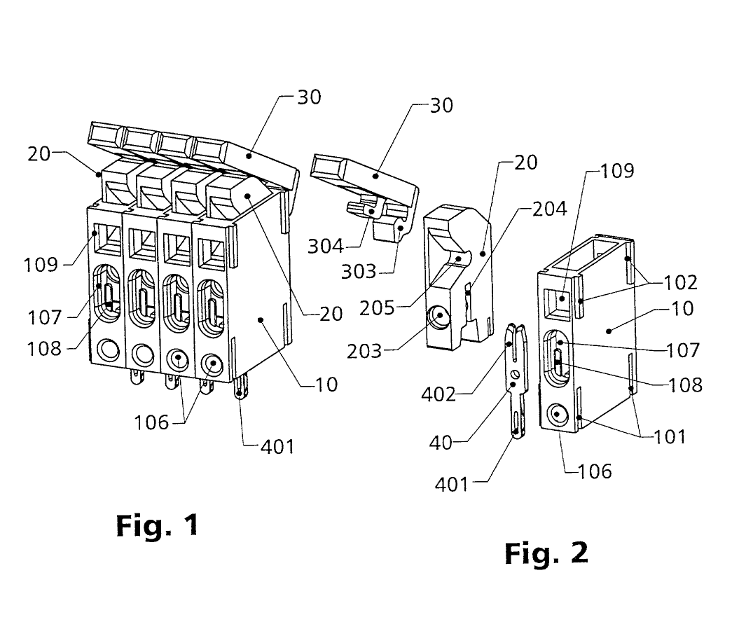

Housing 10 is embodied as a right parallelepiped (e.g., box-like) standing upright. Dovetail grooves 101 and dovetail tongues 102 are molded on the vertical sides of the right parallelepiped, at the top and bottom comers, so that housings 10, each of which includes one connector pole, can be arranged alongside one another so as to form a multi-pole clamping connector, as shown in FIG. 1.

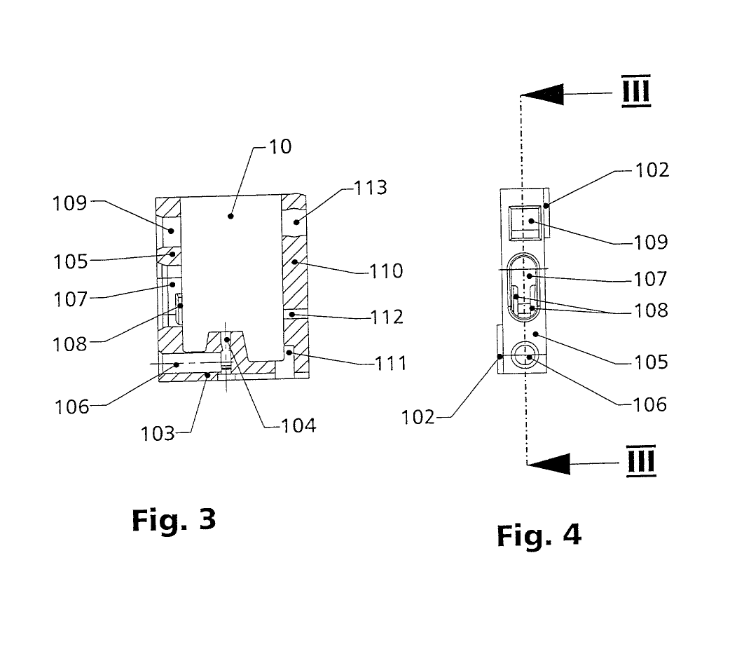

Housing 10, which is in the form of a right parallelepiped, has an inner hollow space in the form of a right parallelepiped which is open on its upper side and closed by base 103 on its lower side. Contact element 40 is pressed into slit 104 in base 103, as can be seen in FIG. 3. Slit 104 has projections which face inwards and which ensure that when contact element 40 is inserted it is subject to a press fit. Contact element 40 has connector 401, which in the exemplary embodiment shown is embodied as a soldering lug. When contact element 40 is inserted, connector 401 protrudes from base 103. The clamping connector may be placed on a PCB (not shown), connector 401 being inserted into the PCB and preferably being soldered to a corresponding printed conductor on the PCB. Insulation displacement contact 402 is formed on the upper end of contact element 40. When contact element 40 is inserted, insulation displacement contact 402 protrudes perpendicularly relative to base 103 freely in the inner hollow space of housing 10. Herein, contact element 40 is arranged more or less in the middle of base 103, and the plane of insulation displacement contact 402 extends parallel to front wall 105 of housing 10.

Test hole 106 leads from front wall 105 to contact element 40. Test hole 106 extends perpendicularly relative to front wall 105 and parallel to base 103. A test probe can be inserted through test hole 106 so as to make contact with contact element 40 when the clamping connector is connected.

Insertion opening 107 having the form of a longitudinal hole whose longitudinal axis extends in the vertical direction is provided in vertical narrow front wall 105 of the housing above test hole 106. A conductor 50 can be inserted into the clamping connector via insertion opening 107. Accordingly, the width of insertion opening 107 is at least equal to the diameter of conductor 50, and its height is at least double the diameter of conductor 50. Insertion opening 107 has, in its lower area and on both sides, terminal strips 108 which protrude forwards and form a clamping gap whose clear width is slightly smaller than the diameter of conductor 50.

Opening 109, which is dimensioned so that it is possible to intervene through opening 109 using a tool, in particular the blade of screwdriver 60, is arranged in front wall 105 of housing 10 above insertion opening 107. The upper edge and the lower edge of opening 109 are horizontal and thus extend parallel to base 103.

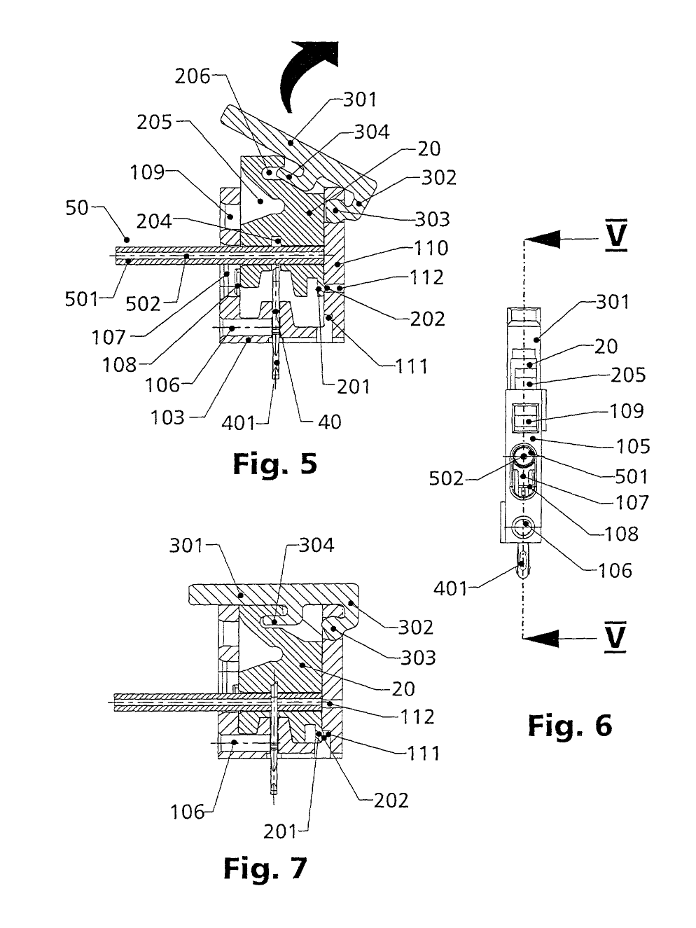

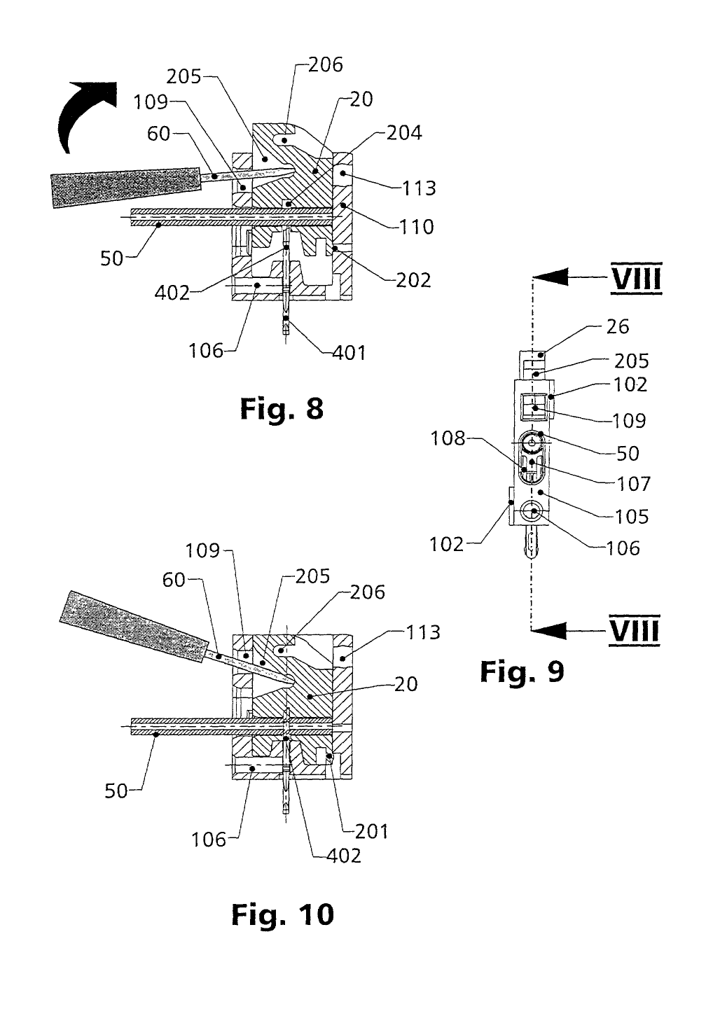

In the right-parallelepiped-shaped inner hollow space of housing 10, pressure element 20 is arranged so that it can move up and down vertically. Accordingly, the horizontal cross section of pressure element 20 matches the inside cross section of the hollow space of housing 10 so that pressure element 20 can move up and down without much sideways play. The lower rear edge of pressure element 20 is designed as flexible tongue 201, which is created by a notch in the base of pressure element 20. Stop projection 202, which faces vertical rear wall 110 of housing 10, is created on flexible tongue 201 via molding. Using this stop projection 202, pressure element 20 can be flexibly locked into lower recess 111 or upper recess 112, both of which are located above one another and at a distance away from each other on rear wall 110. As a result, when pressure element 20 moves vertically, it can assume a lower stop position in housing 10 in which stop projection 202 snaps into lower recess 111 as shown in FIGS. 7 and 10, and an upper stop position in which stop projection 202 snaps into upper recess 112, as shown in FIGS. 5 and 8.

Horizontal hole 203, which extends parallel to base 103 and perpendicular to front wall 105 of housing 10, extends through pressure element 20. The diameter of hole 203 is slightly greater than the outer diameter of conductor 50 that is to be connected. Hole 203 is arranged in pressure element 20 at a given height so that in the upper position of pressure element 20 shown in FIGS. 5 and 8 hole 203 is located in the upper area of insertion opening 107, and in the lower position of pressure element 20 shown in FIGS. 7 and 10 is located in the lower area of insertion opening 107.

Entry slit 204 is provided in the bottom of pressure element 20 and is arranged so that contact element 40 having insulation displacement contact 402 can penetrate this entry slit 204. Entry slit 204 crosses hole 203 inside pressure element 20. In the upper position of pressure element 20 as shown in FIGS. 5 and 8, the upper end of insulation displacement contact 402 is located below hole 203. In the lower position of pressure element 20 shown in FIGS. 7 and 10, insulation displacement contact 402 passes through hole 203 and extends upwards beyond it.

Furthermore, intervention recess 205, which tapers inwards in the vertical plane in the shape of a funnel, is provided on the front of pressure element 20. Herein, the vertical dimension of intervention recess 205 on the front of pressure element 20 is chosen so that the lower edge of intervention recess 205 roughly coincides with the lower edge of opening 109 if pressure element 20 is in the upper position shown in FIGS. 5 and 8, and the upper edge of intervention recess 205 roughly coincides with the upper edge of opening 109 if pressure element 20 is in the lower position shown in FIGS. 7 and 10.

Finger holding recess 206, which extends parallel to the top of pressure element 20 and opens towards the rear, is provided on the top of pressure element 20, which is accessible through the open top of housing 10, the upper rear edge of pressure element 20 being inclined in the direction of the back so as to allow open access to finger holding recess 206, as can be seen in particular in FIGS. 8 and 10.

Operating lever 30 has an essentially straight lever arm 301 which extends across the open upper top of housing 10 and beyond pressure element 20. On the rear end of lever arm 301, projection 302, which is angled downwards and extends into hinge head 303, which faces forwards, is created via molding. Hinge head 303 is in the shape of a circular cylinder having a horizontal axis. Operating lever 30 snaps into hinge seat 113, which is arranged on the rear wall of housing 10 with this hinge head. Hinge seat 113 is in the shape of a horizontal hole in rear wall 110 having concave upper and lower cylinder surfaces which function as bearing surfaces for hinge head 303. During assembly, operating lever 30 can be snapped into hinge seat 113 of housing 10 thanks to hinge head 303, and is then held in housing 10 so that it can swivel about the horizontal axis of hinge head 303.

In the middle section of operating lever 30, on the bottom of lever arm 301, finger 304, which is in the shape of a hook that faces perpendicularly downwards relative to lever arm 301 and is then angled forwards perpendicularly, is created via molding. Finger 304 is designed and arranged so that it extends into finger holding recess 206 of pressure element 20. During assembly of operating lever 30, its hinge head 303 is pressed from the rear into hinge seat 113, while simultaneously finger 304 is pushed from the rear into finger holding recess 206. If hinge head 303 is snapped into place in hinge seat 113, operating lever 30 can be swiveled up and down about the axis of hinge head 303 with the help of its lever arm 301, finger 304 remaining engaged with finger holding recess 206, and pressure element 20 moving up and down. This is shown in FIGS. 5 and 7. Herein, the incline of the upper rear edge of pressure element 20 ensures that lever arm 301 having finger 304, which moves in a circular path, can be tilted, while pressure element 20 moves in a straight path.

To connect a conductor 50 to the clamping connector, pressure element 20 is moved into the upper stop position shown in FIGS. 5 and 8. Hole 203 of pressure element 20 is aligned with the upper end of insertion opening 107 and is located above the upper end of insulation displacement contact 402. Conductor 50 is now inserted through insertion opening 107 into hole 203, as shown in FIGS. 6 and 9. Next, pressure element 20 is moved into the lower position shown in FIGS. 7 and 10. Herein, insulation displacement contact 402 penetrates entry slit 204, pierces insulating material 501 of conductor 50, and makes contact under pressure with conductive core 502 of conductor 50. Simultaneously, in the area of insertion opening 107 conductor 50 is pressed into the clamping gap formed by terminal strips 108, terminal strips 108 pressing into insulating material 501 of conductor 50. Herein, the fact that conductor 50 is clamped between terminal strips 108 ensures that the contact for conductor 50 established by insulation displacement contact 102 is subject to additional strain relief.

If pressure element 20 is moved out of the position shown in FIGS. 7 and 10 back up into the position shown in FIGS. 5 and 8, conductor 50 is lifted back out of insulation displacement contact 402 and out of terminal strips 108. Conductor 50 can then be pulled back forwards out of hole 203 and thus out of the clamping connector in order to break the connection.

The upward and downward movement of pressure element 20 can be carried out with the help of operating lever 30 as shown in FIGS. 5 and 7. Herein, operating lever 30 is grasped manually at its free front end, which preferably extends across front wall 105 of housing 10. The length of lever arm 301 from rear hinge head 303 to the front free end ensures the lever arm is long enough to transfer to pressure element 20 the force required to ensure that insulation displacement contact 402 pierces insulating material 501 of conductor 50 and to ensure that conductor 50 can, vice versa, be lifted out of insulation displacement contact 402.

Alternatively, pressure element 20 can be moved up and down with the help of a suitable tool, e.g. screwdriver 60, as shown in FIGS. 8 and 10. If pressure element 20 is in the upper position shown in FIG. 8, screwdriver 60 can be inserted through opening 109 into intervention recess 205. Screwdriver 60 is then swiveled upwards, its blade resting against the upper edge of opening 109, which thus constitutes the point of support for swiveling the blade of screwdriver 60. The tip of the blade of screwdriver 60, which penetrates intervention recess 205, then pushes pressure element 20 downwards using the leverage action via screwdriver 60. In order to move pressure element 20 back up out of the lower position shown in FIG. 10, screwdriver 60 is inserted through opening 109 into intervention recess 205. Screwdriver 60 is then swiveled downwards, its blade resting on the lower edge of opening 109, as shown in FIG. 10. The tip of the blade then pushes pressure element 20 upwards thanks to the exertion of leverage via screwdriver 60, the lower edge of opening 109 constituting the pivot point for swiveling.

While the invention has been disclosed in connection with various embodiments, modifications thereon will be readily apparent to those skilled in the art. Accordingly, the spirit and scope of the invention is set forth in the following claims.

What is claimed is:

1. A clamping connector, comprising:
at least one housing made of an insulating material, a contact element inserted in the base of the housing which has a connector which protrudes from the base and an insulation displacement contact which extends into the housing;
a pressure element made of an insulating material which is movably guided up and down in the housing and has a hole which is parallel to the base of the housing and perpendicular to the front of the housing into which a conductor to be connected can be inserted via an insertion opening in the front wall, the hole being located above the insulation displacement contact when the pressure element is in an upper position, and the insulation displacement contact penetrating the pressure element and establishing a contact with the conductor that has been inserted into the hole when the pressure element is in a lower position; and
wherein an operating lever for moving the pressure element is swivelably mounted in the housing and acts on the pressure element above the hole.

2. The clamping connector according to claim 1, wherein the operating lever is swivelably mounted on the rear wall of the housing which faces away from the front wall, and its free end extends forwards and is accessible at the front wall of the housing.

3. The clamping connector according to claim 2, wherein the operating lever is arranged above the open top of the housing and acts on the top of the pressure element.

4. The clamping connector according to claim 3, wherein the operating lever has on its underside a finger which engages with a finger holding recess on the top of the pressure element.

5. The clamping connector according to claim 2, wherein the operating lever is a separate component that can be snapped into a hinge seat of the housing using a hinge head.

6. The clamping connector according to claim 1, wherein the pressure element has on its front an intervention recess into which a tool may be inserted through an opening in the front wall of the housing, the tool being swiveled vertically to move the pressure element up and down and resting on the lower or upper edge of the opening.

7. The clamping connector according to claim 1, wherein in its upper and lower position the pressure element flexibly snaps into the housing.

8. The clamping connector according to claim 1, wherein each housing holds one connector pole and can be attached to further housings via a joint to create a multi-pole clamping connector.

9. The clamping connector according to claim 1, wherein in the base of the housing a test hole leads from the front wall to the contact element.

10. A clamping connector comprising:
a housing having a first hole formed therein and a contact element; and
a pressure element arranged in the housing such that said pressure element can move up and down in said housing, said pressure element having a second hole, said first and second holes capable of receiving a conductor to be connected, said pressure element having a first upward position and a second lower position such that when said pressure element is arranged in said second lower position, a conductor inserted into said first and second holes is connected to a portion of said contact element.

11. The clamping connector of claim 10, wherein, when said pressure element is in said first upward position, an upper end of an insulation displacement contact of said contact element is located below said second hole, and, when said pressure element is in said second lower position, said insulation displacement contact passes through the second hole.

12. The clamping connector of claim 10, further comprising:
an operating lever connected to said housing at a contact point such that said operating lever can swivel about a horizontal access of said contact point, said operating lever acting on said pressure element moving said pressure element between said first upward position and said second lower position.

13. The clamping connector of claim 10, further comprising:
an intervention recess included in said pressure element into which a tool is inserted and swiveled vertically to facilitate movement of said pressure element between said first upward position and said second lower position.

14. The clamping connector of claim 10, wherein said contact element includes an insulation displacement contact and a connector, said connector protruding from said housing and said contact element being inserted into an opening in said housing, wherein, when said pressure element is in said second lower position, said insulation displacement contact pierces an insulating material of said conductor making contact with a conductive core of said conductor.

15. The clamping connector of claim 12, wherein said contact element includes a connector and an insulation displacement contact and said operating lever including on its underside a finger that extends into a finger recess of said pressure element.

16. The clamping connector of claim 15, wherein a lower rear end of the pressure element has a flexible tongue formed by a notch in a base of said pressure element.

17. The clamping connector of claim 16, wherein a stop projection is created on said flexible tongue, said housing including a lower stop position into which said stop projection is inserted when locking said pressure element in said second lower position, said housing including an upper stop position into which said stop project is inserted when locking said pressure element in said first upward position.

18. The clamping connector of claim 17, wherein the housing, the pressure element and the operating lever are made of an insulating material.

19. The clamping connector of claim 15, wherein said connector is a soldering lug.

20. The clamping connector of claim 10, wherein said housing includes a base having a slit into which said contact element is inserted, said slit having projections facing inwards ensuring a press fit of said contact element in said base, said contact element including a connector protruding from said base.

21. The clamping connector of claim 10, wherein the housing includes a test hole leading to the contact element, said test hole capable of receiving a test probe to make contact with the contact element.

22. The clamping connector of claim 21, wherein said first hole in said housing is in a front wall of the housing above the test hole capable of receiving a conductor, said first hole having terminal strips in a lower area and on both sides that protrude forward and form a clamping gap having a width smaller than that of the conductor

23. The clamping connector of claim 12, wherein at least one of the housing, pressure element and operating lever is a plastic injection-molded component.

24. The clamping connector of claim 12, wherein said operating lever is a separate component that can be snapped into a hinge seat included in said housing.

25. The clamping connector of claim 12, wherein said pressure element snaps into said housing.

26. The clamping connector of claim 10, wherein said housing holds one connector pole and may be attached to other housings creating a multi-pole clamping connector.

27. A method of connecting a conductor to a clamping connector comprising:
positioning a pressure element arranged in a housing in an upper position, wherein, in said upper position, a hole in said pressure element is aligned with another hole in said housing;
inserting said conductor through said hole in said pressure element and said other hole in said housing; and
positioning said pressure element into a lower position, wherein, in said lower position, an insulation displacement contact, extending into said housing, passes through the hole of said pressure element making contact with a core included in said conductor.

28. The method of claim 27, further comprising:
pressing the conductor into a clamp gap formed by terminal strips of said hole in said housing, said terminal strips pressing into an insulating material of said conductor.

29. The method of claim 28, further comprising:
positioning said pressure element into said upper position lifting said conductor out of said insulating displacement contact and out of said terminal strips.

30. The method of claim 29, further comprising:
removing said conductor breaking an electrical connection.

31. The method of claim 27, wherein said positioning said pressure element into one of said upper and lower positions includes using an operating lever that is swivelably mounted to said housing, a length of said operating lever having a length sufficient to transfer to the pressure element an amount of force for piercing a layer of insulating material of said conductor.

32. The method of claim 27, wherein said positioning said pressure element into one of said upper and lower positions includes using a tool to position said pressure element, comprising:
inserting said tool into an opening of said housing into a recess of said pressure element; and
swiveling said tool in a direction placing said pressure element into said one of said upper and lower positions.

33. The method of claim 32, wherein said tool is a screwdriver.
